(19) United States
(12) Patent Application Publication
(10) Pub. No.: US 2022/0066582 A1
(43) Pub. Date: Mar. 3, 2022

(54) FILM TOUCH SENSOR AND MANUFACTURING METHOD THEREFOR

(71) Applicant: DONGWOOD FINE-CHEM CO., LTD., Iksan-si, Jeollabuk-do (KR)

(72) Inventors: Seonghwan PARK, Hwaseong-si (KR); Sangkook KIM, Pyeongtaek-si (KR); Sung Hoon CHO, Hwaseong-si (KR)

(73) Assignee: DONGWOOD FINE-CHEM CO., LTD., Iksan-si, Jeollabuk-do (KR)

(21) Appl. No.: 17/423,731

(22) PCT Filed: Jan. 15, 2020
(86) PCT No.: PCT/KR2020/000738

§ 371 Date: Jul. 16, 2021

(30) Foreign Application Priority Data
Jan. 22, 2019 (KR) 10-2019-0008383

(51) Int. Cl. G06F 3/044; C09D 145/00

(52) U.S. Cl. CPC G06F 3/044; G06F 2203/04103; C09D 145/00

(57) ABSTRACT

Provided is a film touch sensor comprising a separation layer; a protective layer formed on the separation layer; an electrode pattern layer formed on the protective layer; and an insulation layer formed on the electrode pattern layer, wherein the protective layer is a cured layer of a protective layer forming composition comprising a cyclic olefin polymer having a protonic polar group and a curing agent comprising a polyamide-imide resin in a specific mixing ratio. The film touch sensor has improved mechanical properties of the protective layer, so that the occurrence of cracks can be suppressed during a manufacturing process or transfer.

### TECHNICAL FIELD

The present invention relates to a film touch sensor and a method for preparing the same. More particularly, the present invention relates to a film touch sensor of which a protective layer has improved mechanical properties, thereby suppressing the occurrence of cracks, and a method for preparing the same.

### BACKGROUND ART

A touch sensor is a device detecting a touch point in response to the touch by users when touching an image displayed on the screen by a finger or a touch pen, etc., and is manufactured in a structure mounted on a flat panel display device such as a liquid crystal display (LCD), an organic light-emitting diode (OLED), etc.

Recently, development of flexible display devices which can be rolled or folded like paper has been focused. Accordingly, the touch sensor attached to the flexible display device also needs to have flexibility.

A substrate used for the flexible touch sensor needs to be thin and flexible, but it is difficult to form a touch sensor on such a substrate, and thus the touch sensor is formed using a carrier substrate. After that, a base film is attached onto the touch sensor, and then the touch sensor is separated from the carrier substrate and is attached on a desired flexible display device, followed by removing the base film. In accordance with the process, a flexible display device having a touch sensor attached thereto can be manufactured [see Korean Patent Application Publication No. 10-2016-0114317].

The transfer-type touch sensor has a problem that cracks occur due to stress applied to the touch sensor during a manufacturing process or transfer.

Therefore, the technology development for a film touch sensor capable of suppressing crack occurrence has been required.

### DISCLOSURE

### Technical Problem

It is an object of the present invention to provide a film touch sensor of which the protective layer has improved mechanical properties, thereby suppressing the occurrence of cracks.

It is another object of the present invention to provide a method for preparing the film touch sensor.

### Technical Solution

In one aspect, the present invention provides a film touch sensor, comprising:

a separation layer;

a protective layer formed on the separation layer;

an electrode pattern layer formed on the protective layer; and

an insulation layer formed on the electrode pattern layer,

wherein the protective layer is a cured layer of a protective layer forming composition comprising a cyclic olefin polymer having a repeating unit of formula (1) and a curing agent comprising a polyamide-imide resin,

wherein a mixing ratio of the cyclic olefin polymer to the curing agent is 30:1 to 4:1 by weight:

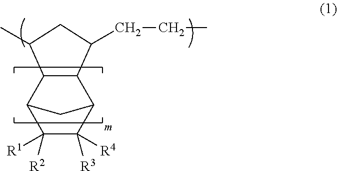

wherein,

R¹ to R⁴ are each independently hydrogen atom or —Xₙ—R′,

X is a divalent organic functional group, n is 0 or 1, and R′ is a substituted or unsubstituted C₁-C₇ alkyl group, a substituted or unsubstituted aromatic group, or a protonic polar group,

at least one of R¹ to R⁴ is —Xₙ—R′ wherein R′ is a protonic polar group, and

m is an integer of 0 to 2.

In one embodiment of the present invention, the protonic polar group may be selected from a group consisting of a carboxyl group, sulfonic acid group, phosphoric acid group, hydroxyl group, amino group, amide group, imide group and thiol group.

In one embodiment of the present invention, the cyclic olefin polymer may further have a repeating unit of formula (2):

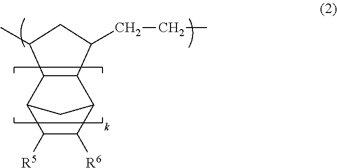

wherein,

R⁵ and R⁶ taken together with the two carbon atoms to which they are attached form a substituted or unsubstituted 3-membered or 5-membered heterocycle having oxygen atom or nitrogen atom, and

k is an integer of 0 to 2.

In one embodiment of the present invention, the cyclic olefin polymer may have a weight average molecular weight of 5,000 to 150,000.

In one embodiment of the present invention, the cyclic olefin polymer may have a glass transition temperature of 100° C. or higher.

In one embodiment of the present invention, the polyamide-imide resin may be represented by formula (3) or (4):

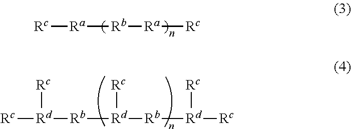

wherein,

R^{b} is a structural unit of any one of formulae (5) to (7),

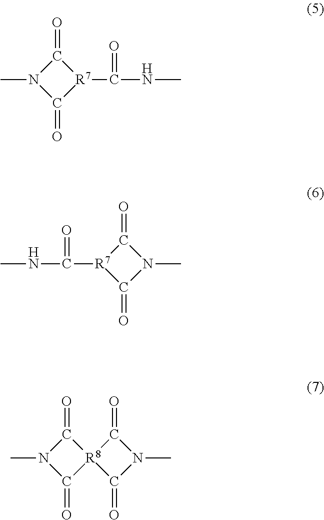

R^{c} is a structural unit of any one of formulae (8) to (12),

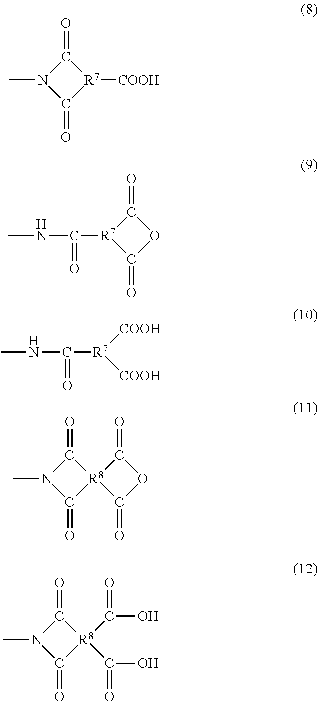

R^{d} is a structural unit of formula (13),

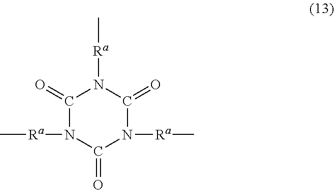

n is an integer of 0 to 30,

R⁷ is a substituted or unsubstituted tricarboxylic anhydride residue having 6 to 20 carbon atoms,

R⁸ is a substituted or unsubstituted tetracarboxylic anhydride residue having 6 to 20 carbon atoms, and

R^{a} is a residue of a divalent aliphatic or alicyclic diisocyanate.

In one embodiment of the present invention, the protective layer may have an elastic modulus of 2.8 to 4.5 GPa.

In one embodiment of the present invention, the protective layer may have a transmittance of 90% or more.

In another aspect, the present invention provides a method for preparing a film touch sensor, comprising the steps of:

a separation layer formation step of forming a separation layer on a carrier substrate;

a protective layer formation step of forming a protective layer on the separation layer;

an electrode pattern layer formation step of forming an electrode pattern layer on the protective layer; and

an insulation layer formation step of forming an insulation layer on the electrode pattern layer,

wherein the protective layer is a cured layer of a protective layer forming composition comprising a cyclic olefin polymer having a repeating unit of formula (1) and a curing agent comprising a polyamide-imide resin,

wherein a mixing ratio of the cyclic olefin polymer to the curing agent is 30:1 to 4:1 by weight:

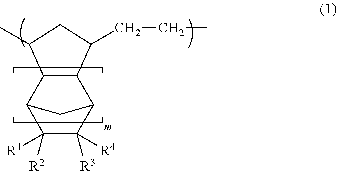

wherein,

R¹ to R⁴ are each independently hydrogen atom or —Xₙ—R′,

X is a divalent organic functional group, n is 0 or 1, and R′ is a substituted or unsubstituted C₁-C₇ alkyl group, a substituted or unsubstituted aromatic group, or a protonic polar group,

at least one of R¹ to R⁴ is R′ is —Xₙ—R′ wherein R′ is a protonic polar group, and

m is an integer of 0 to 2.

In still another aspect, the present invention provides a display device including the film touch sensor.

### Advantageous Effects

The film touch sensor according to the present invention has a protective layer having improved mechanical properties, so that the occurrence of cracks can be suppressed during the manufacturing process or transfer.

Further, the film touch sensor according to the present invention comprises a protective layer having a high glass transition temperature and excellent optical characteristics, and thus durability and visibility can be secured.

### BRIEF DESCRIPTION OF DRAWINGS

FIG. 1 is a cross-sectional view showing the structure of the film touch sensor according to one embodiment of the present invention.

FIG. 2 is a cross-sectional view showing the structure of the film touch sensor according to another embodiment of the present invention.

FIG. 3 schematically shows procedures of the film touch sensor preparation method according to one embodiment of the present invention.

### BEST MODE

Hereinafter, the present invention will be described in detail with reference to accompanying drawings.

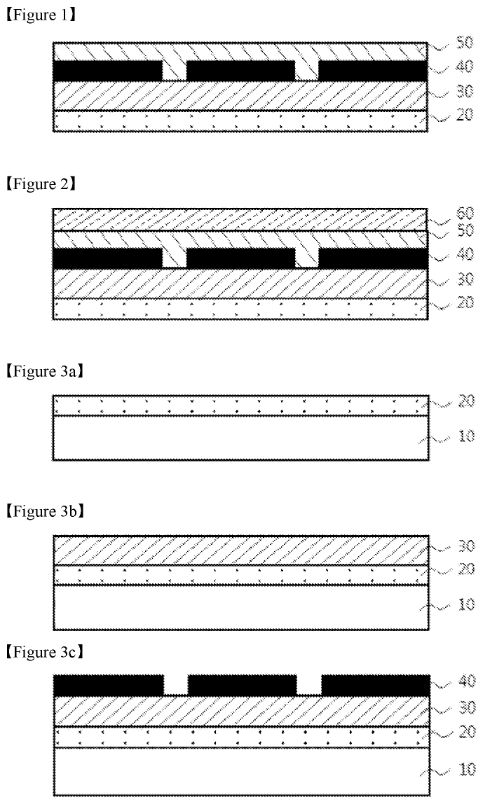

FIG. 1 is a cross-sectional view showing the structure of the film touch sensor according to one embodiment of the present invention.

The present invention is characterized in that: a separation layer is formed on a carrier substrate and a protective layer is formed on the separation layer, followed by the process of sequentially forming an electrode pattern layer and insulation layer thereon; and the separation layer and protective layer can be used as covering layers after separated from the carrier substrate, thereby ensuring high definition and heat resistance which cannot be obtained by a process of directly forming an electrode pattern layer on a base film, and allowing the application of various base films.

According to the present invention, the protective layer is formed using a protective layer forming composition comprising a cyclic olefin polymer having a protonic polar group, and a curing agent comprising a polyamide-imide resin, thereby improving mechanical properties of the protective layer, and suppressing crack occurrence during manufacturing processes or transfer.

One embodiment of the film touch sensor according to the present invention comprises a separation layer 20; a protective layer 30 formed on the separation layer; an electrode pattern layer 40 formed on the protective layer; and an insulation layer 50 formed on the electrode pattern layer, as shown in FIG. 1.

The separation layer 20 is a organic polymer film, and may include, for example, at least one material selected from the group consisting of a polyimide, a polyvinyl alcohol, a polyamic acid, a polyamide, a polyethylene, a polystyrene, a polynorbonene, a phenylmaleimide copolymer, a polyazobenzene, a polyphenylenephthalamide, a polyester, a polymethyl methacrylate, a polyarylate, a cinnamate-based polymer, a melamine-based polymer, a coumarin-based polymer, a phthalimidine-based polymer, a chalcone-based polymer and an aromatic acetylene-based polymer.

The separation layer 20 is applied on a carrier substrate 10. Thereafter, the protective layer 30, the electrode pattern layer 40 and the insulation layer 50 are formed thereon, and then the separation layer 20 is finally separated from the carrier substrate 10.

A peel-off strength of the separation layer 20 is preferably 1N/25 mm or less, more preferably 0.1N/25 mm or less. In other words, it is preferred to form the separation layer 20 using a material controlling the physical strength applied for separating the separation layer 20 from the carrier substrate 10 to 1N/25 mm or less, particularly 0.1N/25 mm or less.

If the peel-off strength of the separation layer 20 exceeds 1N/25 mm, the separation layer 20 may not be clearly separated from the carrier substrate, and thus it may remain on the carrier substrate. Also, cracks may occur in one or more parts of the separation layer 20, the protective layer 30, the electrode pattern layer 40 and the insulation layer 50.

Particularly, it is more preferred that the peel-off strength of the separation layer 20 is 0.1N/25 mm or less, in terms that curls generated in the film after peeling from the carrier substrate can be controlled. Curls do not cause functional problems in the film touch sensor, but may deteriorate the process efficiency in the process such as adhesion process, cutting process and the like, and thus it is advantageous to lower the generation.

Herein, the separation layer 20 preferably has a thickness of 10 to 1000 nm, and more preferably, 50 to 500 nm. If the thickness of the separation layer 20 is less than 10 nm, uniformity during applying the separation layer is deteriorated, so that electrode patterns are unevenly formed, tearing occurs due to a locally increased peel-off strength, or curling of the film touch sensor may not be controlled after the separation from the carrier substrate. If the thickness thereof exceeds 1000 nm, the peel-off strength is not further decreased, and flexibility of the film is deteriorated.

Further, the separation layer preferably has a surface energy of 30 to 70 mN/m after peeled from the carrier substrate, and the difference in surface energy between the separation layer and the carrier substrate is preferably 10 mN/m or more. In the film touch sensor manufacturing process, the separation layer should be stably adhered to the carrier substrate until it is peeled from the carrier substrate, and it should be easily separated when peeling from the carrier substrate so that tearing or curling of the film touch sensor does not occur. When the surface energy of the separation layer is set to 30 to 70 mN/m, the peel-off strength can be adjusted, and the adhesion between the separation layer and the adjacent protective layer or electrode pattern layer is ensured to improve process efficiency. In addition, when the difference in surface energy between the separation layer and the carrier substrate is 10 mN/m or more, the separation layer can be smoothly peeled from the carrier substrate to prevent tearing of the film touch sensor or cracks which may occur in each layer of the film touch sensor.

The separation layer 20 has the electrode pattern layer 40 formed thereon. The separation layer 20 functions as a covering layer which covers the electrode pattern layer 40, or as a protective layer which protects the electrode pattern layer 40 from external contact after it is separated from the carrier substrate.

On the separation layer 20, at least one protective layer 30 is formed. Since only the separation layer 20 may be difficult to protect electrode patterns from external contact or impact, at least one protective layer 30 is formed on the separation layer 20.

In one embodiment of the present invention, the protective layer 30 is a cured layer of a protective layer forming composition, comprising a cyclic olefin polymer having a repeating unit of formula (1) and a curing agent comprising a polyamide-imide resin.

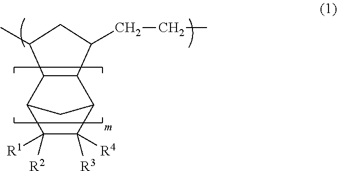

wherein,

R¹ to R⁴ are each independently hydrogen atom or —Xₙ—R′,

X is a divalent organic functional group, n is 0 or 1, and R′ is a substituted or unsubstituted C₁-C₇ alkyl group, a substituted or unsubstituted aromatic group, or a protonic polar group,

at least one of R¹ to R⁴ is —Xₙ—R′ wherein R′ is a protonic polar group, and

m is an integer of 0 to 2.

The term “C₁-C₇ alkyl group” as used herein refers to a linear or branched monovalent hydrocarbon having 1 to 7 carbon atoms. Examples thereof may include methyl, ethyl, n-propyl, i-propyl, n-butyl, i-butyl, t-butyl, n-pentyl, n-hexyl, n-heptyl and the like, but are not limited thereto.

The term “aromatic group” as used herein refers to a 5- to 15-membered simple or fused ring type aromatic hydrocarbon. Examples thereof may include phenyl, benzyl and the like, but are not limited thereto.

Substituents of the C₁-C₇ alkyl group and the aromatic group may be, for example, C₁-C₄ alkyl group such as methyl, ethyl, n-propyl, i-propyl, n-butyl, i-butyl and the like; C₁-C₆ aryl group such as phenyl, xylyl, tolyl, naphthyl and the like.

The term “protonic polar group” as used herein refers to an atomic group in which a hydrogen atom is directly bonded to an atom other than a carbon atom. Herein, the atom other than the carbon atom preferably includes atoms belonging to groups 15 and 16 of the periodic table, more preferably, atoms belonging to the first and second periods of groups 15 and 16 of the periodic table, much more preferably, oxygen, nitrogen and sulfur atoms, and particularly preferably, an oxygen atom. In particular, the protonic polar group may be selected from the group consisting of a carboxyl group (hydroxycarbonyl group), a sulfonic acid group, a phosphoric acid group, a hydroxyl group, an amino group, an amide group, an imide group, and a thiol group, and preferably, a carboxyl group.

In one embodiment of the present invention, X may be C₁-C₇ alkylene group, aromatic group or carbonyl group, for example methylene group, ethylene group, phenylene group and the like.

The repeating unit of formula (1) may be derived from monomers such as a cyclic olefin having a carboxyl group such as 5-hydroxycarbonyl bicyclo[2.2.1]hepto-2-ene, 5-methyl-5-hydroxycarbonyl bicyclo[2.2.1]hepto-2-ene, 5-carboxymethyl-5-hydroxycarbonyl bicyclo[2.2.1]hepto-2-ene, 5-exo-6-endo-dihydroxycarbonyl bicyclo[2.2.1]hepto-2-ene, 8-hydroxycarbonyl tetracyclo[4.4.0.1^{2,5}.1^{7,10}]dodeca-3-ene, 8-methyl-8-hydroxycarbonyl tetracyclo[4.4.0.1^{2,5}.1^{7,10}]dodeca-3-ene, 8-exo-9-endo-dihydroxycarbonyl tetracyclo[4.4.0.1^{2,5}.1^{7,10}]dodeca-3-ene; a cyclic olefin having a hydroxyl group such as 5-(4-hydroxyphenyl)bicyclo[2.2.1]hepto-2-ene, 5-methyl-5-(4-hydroxyphenyl)bicyclo[2.2.1]hepto-2-ene, 8-(4-hydroxyphenyl)tetracyclo[4.4.0.1^{2,5}.1^{7,10}]dodeca-3-ene, 8-methyl-8-(4-hydroxyphenyl)tetracyclo[4.4.0.1^{2,5}.1^{7,10}]dodeca-3-ene. Particularly, it may be derived from the cyclic olefin monomer having a carboxyl group.

In one embodiment of the present invention, the cyclic olefin polymer may further comprise a repeating unit of formula (2).

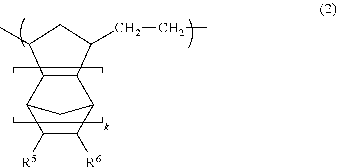

wherein,

R⁵ and R⁶ taken together with the two carbon atoms to which they are attached form a substituted or unsubstituted 3-membered or 5-membered heterocycle having oxygen atom or nitrogen atom, and

k is an integer of 0 to 2.

In one embodiment of the present invention, R⁵ and R⁶ taken together with the two carbon atoms to which they are attached may form substituted or unsubstituted epoxy structure, substituted or unsubstituted dicarboxylic anhydride structure [—C(O)—O—C(O)—], or substituted or unsubstituted dicarboxyimide structure [—C(O)—N—C(O)—]. These may be substituted with, for example, phenyl, naphthyl, anthracenyl and the like.

The repeating unit of formula (2) may be derived from monomers such as N-(4-phenyl)-(5-norbornene-2,3-dicarboxyimide) and the like.

In one embodiment of the present invention, the cyclic olefin polymer may have repeating units other than the repeating unit of formula (1) and the repeating unit of formula (2). For example, repeating units derived from a vinyl alicyclic hydrocarbon monomer, a vinyl aromatic hydrocarbon monomer and a chain olefin monomer to be described below may be exemplified.

Examples of the vinyl alicyclic hydrocarbon monomer may include vinylcyclo alkanes such as vinylcyclo propane, vinylcyclo butane, vinylcyclo pentane, vinylcyclo hexane, vinylcyclo heptane, etc.; vinylcyclo alkanes having a substituent such as 3-methyl-1-vinylcyclo hexane, 4-methyl-1-vinylcyclo hexane, 1-phenyl-2-vinylcyclo propane, 1,1-diphenyl-2-vinylcyclo propane, etc.

Examples of the vinyl aromatic hydrocarbon monomer may include vinyl aromatic compounds such as styrene, 1-vinylnaphthalene, 2-vinylnaphthalene, 3-vinylnaphthalene, etc.; vinyl aromatic compounds having a substituent such as 3-methylstyrene, 4-propylstyrene, 4-cyclohexylstyrene, 4-dodecylstyrene, 2-ethyl-4-benzylstyrene, 4-(phenylbutyl)styrene, etc.; multifunctional vinyl aromatic compounds such as m-divinylbenzene, p-divinylbenzene, bis(4-vinylphenyl)methane, etc.

Examples of the chain olefin monomer may include ethylene; α-olefin having 2 to 20 carbon atoms such as propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, etc.; nonconjugated diene such as 1,4-hexadiene, 4-methyl-1,4-hexadiene, 5-methyl-1,4-hexadiene, 1,7-octadiene, etc. These monomers may be used alone or in combination of two or more.

The repeating unit of formula (1) and the other repeating units may exist in a weight ratio (repeating unit of formula (1)/other repeating units) of commonly 100/0 to 10/90, preferably 90/10 to 20/80, and more preferably 80/20 to 30/70.

Polymerization methods of the above monomers may be carried out according to conventional methods, and for example, a ring-opening polymerization method or an addition polymerization method is employed. As a polymerization catalyst, metal complexes of molybdenum, ruthenium, osmium, etc. may be suitably used. These polymerization catalysts may be used alone or in combination of two or more. For example, when obtaining a ring-opened (co)polymer of the cyclic olefin monomer, an amount of the polymerization catalyst is commonly in a range of 1:100 to 1:2,000,000, preferably 1:500 to 1:1,000,000, and more preferably 1:1,00) to 1:500,000 in terms of a molar ratio of the metal compound in the polymerization catalyst to the cyclic olefin monomer.

The cyclic olefin polymer obtained by the polymerization may be hydrogenated as desired. The hydrogenation is commonly carried out using a hydrogenation catalyst. As the hydrogenation catalyst, for example, catalysts generally used for hydrogenation of an olefin compound may be used. Specifically, a homogeneous Ziegler type catalyst, a noble metal complex catalyst, a supported noble metal catalyst and the like may be used. Among these hydrogenation catalysts, the noble metal complex catalysts of rhodium, ruthenium, etc. are preferably used since they can selectively hydrogenate a carbon-carbon unsaturated bond in the polymer without causing a side reaction such as modification of a functional group such as a protonic polar group, and it is more preferred to use a ruthenium catalyst in which nitrogen-containing heterocyclic carbene compounds having high electron-donating ability or phosphines are coordinated. Meanwhile, the hydrogenation rate of the cyclic olefin polymer is preferably 80% or more, and more preferably 90% or more.

In one embodiment of the present invention, the cyclic olefin polymer having the protonic polar group-containing repeating unit of formula (1) may also be obtained by introducing a protonic polar group into a cyclic olefin polymer having no protonic polar group by a known method using a modifying agent. In this case, hydrogenation may be performed to the polymer before and after the introduction of the protonic polar group.

As a modifying agent for introducing the protonic polar group into the cyclic olefin polymer having no protonic polar group, a compound having a reactive carbon-carbon unsaturated bond and a protonic polar group in one molecule is generally used. Specific examples of such a compound may include unsaturated carboxylic acids such as acrylic acid, methacrylic acid, angelic acid, tiglic acid, oleic acid, elaidic acid, erucic acid, brassidic acid, maleic acid, fumaric acid, citraconic acid, mesaconic acid, itaconic acid, atropic acid, cinnamic acid, etc.; unsaturated alcohols such as allyl alcohol, methylvinyl methanol, crotyl alcohol, methallyl alcohol, 1-phenylethene-1-ol, 2-propan-1-ol, 3-butene-1-ol, 3-butene-2-ol, 3-methyl-3-butene-1-ol, 3-methyl-2-butene-1-ol, 2-methyl-3-butene-2-ol, 2-methyl-3-butene-1-ol, 4-pentene-1-ol, 4-methyl-4-pentene-1-ol, 2-hexene-1-ol, etc. The modification reaction may be carried out according to a conventional method, and commonly performed in the presence of a radical generator. These modifying agents may be used alone or in combination of two or more.

In a method of preparing the cyclic olefin polymer having a protonic polar group-containing repeating unit of formula (1), a precursor of the protonic polar group may be used instead of the protonic polar group. That is, a monomer having a precursor of the protonic polar group may be used instead of a monomer having the protonic polar group. As the modifying agent, a modifying agent having a precursor of the protonic polar group may be used instead of the protonic polar group. The precursor of the protonic polar group is converted to the protonic polar group by decomposition due to light or heat, a chemical reaction such as hydrolysis and the like, according to the type thereof.

For example, when the protonic polar group in the cyclic olefin polymer having a protonic polar group-containing repeating unit of formula (1) is a carboxyl group, an ester group may be used as a precursor of the protonic polar group, and then converted to an appropriate carboxyl group.

The cyclic olefin polymer may have a weight average molecular weight of 5,000 to 150,000. If the weight average molecular weight is less than 5,000, cracks may occur during peeling, and if the weight average molecular weight exceeds 150,000, wrinkles may be formed on the protective layer during deposition of a metal layer on the protective layer.

A molecular weight distribution of the cyclic olefin polymer may be, in terms of a ratio of weight average molecular weight to number average molecular weight (Mw/Mn), 4 or less, preferably 3 or less, and for example 1 to 3.

The cyclic olefin polymer may have an iodine value of 200 or less, preferably 50 or less, and more preferably 10 or less. When the iodine value is within the above range, it is preferable due to particularly excellent heat-resistant shape retention.

The glass transition temperature (Tg) of the cyclic olefin polymer may be 100° C. or higher, for example 100 to 300° C. By having such a high glass transition temperature, the protective layer 30 including the polymer may have high heat resistance, and thus heat damage such as wrinkles, cracks, and discoloration which may occur in the high temperature deposition and annealing processes during the electrode pattern layer formation can be suppressed. Further, solvent resistance to various solvents such as an etchant and a developing solution which may be exposed during the electrode pattern layer formation is excellent.

The cyclic olefin polymer may be contained in an amount of 1 to 30% by weight based on 100% by weight of the total protective layer forming composition. If the amount of the cyclic olefin polymer is within the above range, heat-resistance and flexibility of the protective layer are excellent.

The polyamide-imide resin may be represented by formula (3) or (4).

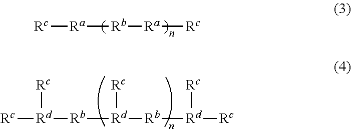

wherein,

R^{b} is a structural unit of any one of formulae (5) to (7),

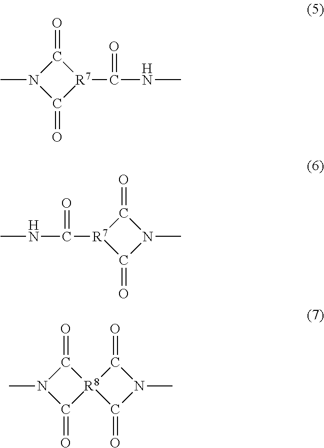

R^{c} is a structural unit of any one of formulae (8) to (12),

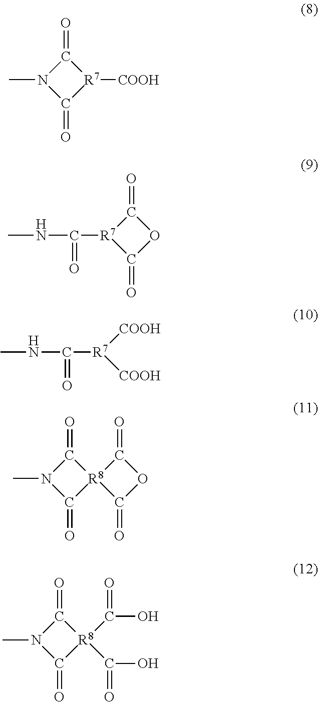

R^{d} is a structural unit of formula (13),

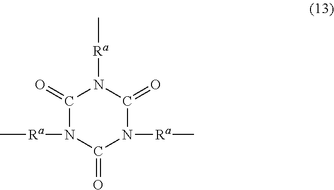

n is an integer of 0 to 30,

R⁷ is a substituted or unsubstituted tricarboxylic anhydride residue having 6 to 20 carbon atoms,

R⁸ is a substituted or unsubstituted tetracarboxylic anhydride residue having 6 to 20 carbon atoms, and

R^{a} is a residue of a divalent aliphatic or alicyclic diisocyanate.

In one embodiment of the present invention, the substituted or unsubstituted tricarboxylic anhydride having 6 to 20 carbon atoms may be trimellitic anhydride, naphthalene-1,2,4-tricarboxylic anhydride, propanetricarboxylic anhydride, cyclohexane tricarboxylic anhydride, methylcyclohexane tricarboxylic anhydride, cyclohexene tricarboxylic anhydride, methylcyclohexene tricarboxylic anhydride and the like, but is not limited thereto.

In one embodiment of the present invention, the substituted or unsubstituted tetracarboxylic anhydride having 6 to 20 carbon atoms may be pyromellitic dianhydride, benzophenone 3,3′,4,4′-tetracarboxylic dianhydride, diphenyl ether-3,3′,4,4′-tetracarboxylic dianhydride, benzene 1,2,3,4-tetracarboxylic dianhydride, biphenyl-3,3′4,4′-tetracarboxylic dianhydride, biphenyl-2,2′,3,3′-tetracarboxylic dianhydride, naphthalene-2,3,6,7-tetracarboxylic dianhydride, naphthalene-1,2,4,5-tetracarboxylic dianhydride, naphthalene-1,4,5,8-tetracarboxylic dianhydride, decahydronaphthalene-1,4,5,8-tetracarboxylic dianhydride, 4,8-dimethyl-1,2,3,5,6,7-hexahydronaphthalene-1,2,5,6-tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene 1,3,9,10-tetracarboxylic dianhydride, perylene 3,4,9,10-tetracarboxylic dianhydride, bis(2,3-dicarboxyphenyl) methane dianhydride, bis(3,4-dicarboxyphenyl) methane dianhydride, 1,1-bis(2,3-dicarboxyphenyl) ethane dianhydride, 1,1-bis(3,4-dicarboxyphenyl) ethane dianhydride, 2,2-bis(2,3-dicarboxyphenyl) propane dianhydride, 2,3-bis(3,4-dicarboxyphenyl) propane dianhydride, bis(3,4-dicarboxyphenyl) sulfone dianhydride, bis(3,4-dicarboxyphenyl) ether dianhydride and the like, but is not limited thereto.

In one embodiment of the present invention, the aliphatic or alicyclic diisocyanate may be hexamethylene diisocyanate, isophorone diisocyanate, hydrogenated tolylene diisocyanate, hydrogenated xylene diisocyanate, norbornane diisocyanate, hydrogenated diphenylmethane diisocyanate and the like, but is not limited thereto.

The polyamide-imide resin of formula (3) can be obtained by reacting an aliphatic or alicyclic diisocyanate with a substituted or unsubstituted tricarboxylic anhydride having 6 to 20 carbon atoms and/or a substituted or unsubstituted tetracarboxylic anhydride having 6 to 20 carbon atoms.

The polyamide-imide resin of formula (4) can be obtained by reacting an isocyanurate-type polyisocyanate synthesized from an aliphatic or alicyclic diisocyanate, with a substituted or unsubstituted tricarboxylic anhydride having 6 to 20 carbon atoms and/or a substituted or unsubstituted tetracarboxylic anhydride having 6 to 20 carbon atoms.

Specific commercially available products of the polyamide-imide resin may include EMG-1015, ELG-503, EPG-630 from DIC Corporation, etc., and these may be used alone or in combination of two or more.

The curing agent comprising the polyamide-imide resin may be contained in an amount of 0.1 to 4% by weight, preferably 0.5 to 3% by weight, based on 100% by weight of the total protective layer forming composition. If the content of the curing agent comprising the polyamide-imide resin is within the above range, flexibility and heat resistance are excellent.

The mixing ratio of the cyclic olefin polymer to the curing agent is 30:1 to 4:1 by weight, preferably 28:1 to 7:1, and most preferably 15:1. In the mixing ratio of the cyclic olefin polymer and the curing agent, if the amount of the cyclic olefin polymer is less than the above range, cracks may occur during curing after application on a substrate, and if it exceeds the above range, flexibility may be deteriorated.

The film touch sensor according to one embodiment of the present invention improves the mechanical properties of the protective layer by reacting the protonic polar group of the cyclic olefin polymer with the amide group and/or imide group of the curing agent in the protective layer, thereby suppressing the occurrence of cracks due to stress applied to the touch sensor during the manufacturing process or transfer. Particularly, in the case of using the curing agent comprising the polyamide-imide resin formed by the reaction of an aliphatic or alicyclic diisocyanate with a tricarboxylic anhydride and/or tetracarboxylic anhydride, or formed by the reaction of an isocyanurate-type polyisocyanate synthesized from an aliphatic or alicyclic diisocyanate with a tricarboxylic anhydride and/or a tetracarboxylic anhydride, as the polyamide-imide resin of formula (3) or (4), it is more advantageous to improve the mechanical properties of the protective layer, and also preferable in terms of flexibility and heat resistance.

Further, since the protective layer 30 has excellent elasticity, cracks which may occur during peeling from the carrier substrate may be reduced. The elastic modulus of the protective layer may be, for example, 2.8 to 4.5 GPa. If the elastic modulus of the protective layer is less than 2.8 GPa, wrinkles may be formed on the protective layer when a metal layer is deposited on the protective layer, and if the elastic modulus exceeds 4.5 GPa, cracks may occur during peeling from the carrier substrate. The elastic modulus of the above range can be obtained, for example, by setting the post-bake temperature to 180° C. or higher.

The protective layer 30 may have a transmittance of 90% or more, preferably 92% or more. The transmittance of the above range can be obtained, for example, by performing the post-bake at 180° C. to 250° C.

The thickness of the protective layer 30 is not particularly limited, but may be, for example, 0.5 to 100 μm. If the thickness is less than 0.1 μm, cracks may occur during peeling from the carrier substrate, and if the thickness exceeds 100 μm, a white cast phenomenon may occur due to defective application.

An electrode pattern layer 40 is formed on the protective layer 30. The electrode pattern layer 40 is configured to comprise a sensing electrode SE for sensing a touch, and a pad electrode PE formed at one end of the sensing electrode SE. Herein, the sensing electrode SE may comprise not only an electrode for sensing a touch, but also a wiring pattern connected to the electrode. The pad electrode PE may be electrically connected to the circuit board.

The electrode pattern layer 40 is a transparent conductive layer, and may be formed from at least one material selected from the group consisting of a metal, a metal nanowire, a metal oxide, carbon nanotube, graphene, a conductive polymer and a conductive ink.

Herein, the metal may be any one of gold (Au), silver (Ag), copper (Cu), molybdenum (Mo), aluminum, palladium, neodymium, and an alloy of Ag—Pd—Cu (APC).

Further, the metal nanowire may be any one of silver nanowire, copper nanowire, zirconium nanowire, and gold nanowire.

In addition, the metal oxide may be any one of indium tin oxide (ITO), indium zinc oxide (IZO), indium zinc tin oxide (IZTO), aluminum zinc oxide (AZO), gallium zinc oxide (GZO), fluorine-doped tin oxide (FTO), zinc oxide (ZnO), indium tin oxide-Ag-indium tin oxide (ITO-Ag-ITO), indium zinc oxide-Ag-indium zinc oxide (IZO-Ag-IZO), indium zinc tin oxide-Ag-indium zinc tin oxide (IZTO-Ag-IZTO), and aluminum zinc oxide-Ag-aluminum zinc oxide (AZO-Ag-AZO).

Also, the electrode pattern layer 40 may be formed from carbon materials including carbon nanotube (CNT) and graphene.

The conductive polymer may comprise polypyrrole, polythiophene, polyacetylene, PEDOT and polyaniline or may be formed therefrom.

The conductive ink may be a mixture of metal powder and a curable polymer binder, and it may be used to form an electrode.

As the pattern structure of the electrode pattern layer, the electrode pattern structure used in capacitance mode is preferred, and mutual-capacitance mode or self-capacitance mode may be applied.

The mutual-capacitance mode may have a grid electrode structure of a horizontal axis and a vertical axis. The point of intersection between electrodes on the horizontal axis and the vertical axis may have a bridge electrode. Alternatively, the electrode pattern layers on the horizontal axis and the vertical axis may be respectively formed and each of them may be electrically apart from each other.

The self-capacitance mode may have an electrode layer structure that recognizes the change of capacitance using one electrode in each position.

On the electrode pattern layer 40, an insulation layer 50 is formed. The insulation layer may serve to inhibit the corrosion of the electrode pattern and protect the surface of the electrode pattern. The insulation layer 50 fills a gap in the electrode or the wiring and it is preferably formed to have a constant thickness. That is, it is preferred to evenly form the surface of the opposite side to the surface contacting with the electrode pattern layer 40 so that the uneven part of the electrode is not exposed.

The insulation layer is not particularly limited as long as it is an organic insulating material, but a thermosetting or UV curable organic polymer is preferably used.

The thickness of the insulation layer 50 is not particularly limited, but is commonly in the range of 0.1 to 100 μm, preferably 0.5 to 50 μm, and more preferably 0.5 to 30 μm.

The film touch sensor according to another embodiment of the present invention may further comprise a base film 60 attached on the insulation layer 50, as shown in FIG. 2.

In the present invention, the base film 60 may be a transparent film or a polarizing plate.

As the transparent film, films having good transparency, mechanical strength and thermal stability can be used. Specific examples of the transparent film may include a film consisting of thermoplastic resins, e.g., polyester resins such as polyethylene terephthalate, polyethylene isophthalate, polyethylene naphthalate and polybutylene terephthalate; cellulose resins such as diacetylcellulose and triacetylcellulose; polycarbonate resins; acrylate resins such as polymethyl (meth)acrylate and polyethyl (meth)acrylate; styrene resins such as polystyrene and acrylonitrile-styrene copolymer; polyolefin resins such as polyethylene, polypropylene, polyolefin having a cyclic or norbornene structure, and ethylene-propylene copolymer; vinyl chloride resins; amide resins such as nylon and aromatic polyamide; imide resins; polyethersulfone resins; sulfone resins; polyether ether ketone resins; polyphenylene sulfide resins; vinyl alcohol resins; vinylidene chloride resins; vinyl butyral resins; allylate resins; polyoxymethylene resins; and epoxy resins. Also, a film consisting of a blend of the thermoplastic resins may be used. In addition, thermosetting or UV curable resins such as (meth)acrylate, urethane, acrylic urethane, epoxy and silicon resins may be used. The transparent film may have a suitable thickness, but considering workability such as strength and handling property, or thin layer property, the thickness of the transparent film is commonly in the range of 1 to 500 μm, preferably 1 to 300 μm, and more preferably 5 to 200 μm.

Also, the transparent film may be an isotropic film, a retardation film or a protective film.

The polarizing plate may be any one known to be used in a display panel.

Specifically, the polarizing plate may be prepared by laminating a protective layer on at least one surface of a polarizer obtained by dying iodine or a dichroic colorant on a stretched polyvinyl alcohol film, by orienting a liquid crystal so as to provide a polarizer function, or by coating an orientation resin such as polyvinyl alcohol on a transparent film, followed by stretching and dying, but is not limited thereto.

The base film 60 may be attached using a PSA/adhesive.

The PSA/adhesive refers to a pressure-sensitive adhesive (PSA) or an adhesive.

As the pressure-sensitive adhesive or adhesive, a thermosetting or photocurable pressure-sensitive adhesive or adhesive known in the art may be used without limitation. For example, a thermosetting or photocurable pressure-sensitive adhesive or adhesive such as polyester-based adhesive, polyether-based adhesive, urethane-based adhesive, epoxy-based adhesive, silicone-based adhesive, and acrylic adhesive may be used.

In the film touch sensor of the present invention, the pad electrode may electrically connect with a circuit board. The circuit board may be, for example, a flexible printed circuit board (FPCB) and functions to electrically connect the touch sensor with a touch control circuit.

In one embodiment of the present invention, the carrier substrate 10 may be a glass, but is not limited thereto, and other kinds of substrate may be used as the carrier substrate 10. However, it is preferred to use materials which are not deformed at a high temperature in order to endure a process temperature for electrode formation, that is, heat-resistant materials which can maintain planarization at a high temperature.

Hereinafter, a method for preparing the above-mentioned film touch sensor according to the present invention will be described.

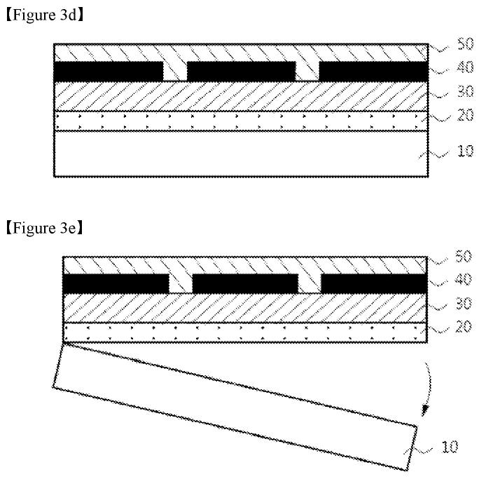

FIGS. 3a to 3e schematically show the procedures for preparing a film touch sensor according to one embodiment of the present invention.

As shown in FIG. 3a, a carrier substrate 10 is coated with an organic polymer film to form a separation layer 20.

The formation of the separation layer may be carried out by a conventional coating method known in the art.

For example, spin coating, die coating, spray coating, roll coating, screen coating, slit coating, dip coating, gravure coating and the like may be mentioned.

For the curing process for forming the separation layer 20, thermal curing and UV curing may be carried out alone or in combination thereof.

The carrier substrate 10 may be a glass, but is not limited thereto, and other kinds of substrate may be used as the carrier substrate 10. However, it is preferred to use materials which are not deformed at a high temperature in order to endure a process temperature for electrode pattern formation, that is, heat-resistant materials which can maintain planarization at a high temperature.

As shown in FIG. 3b, a protective layer 30 is formed on the separation layer 20 formed on the carrier substrate 10.

The protective layer can be formed by coating and curing a protective layer forming composition comprising a cyclic olefin polymer having a repeating unit of formula (1) and a curing agent comprising a polyamide-imide resin on the separation layer.

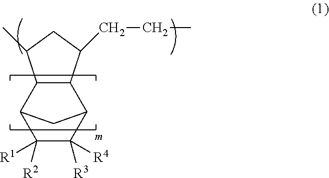

wherein,

R¹ to R⁴ are each independently hydrogen atom or —Xₙ—R′,

X is a divalent organic functional group, n is 0 or 1, and R′ is a substituted or unsubstituted C₁-C₇ alkyl group, a substituted or unsubstituted aromatic group, or a protonic polar group,

at least one of R¹ to R⁴ is —Xₙ—R′ wherein R′ is a protonic polar group, and

m is an integer of 0 to 2.

The cyclic olefin polymer may further have a repeating unit of formula (2).

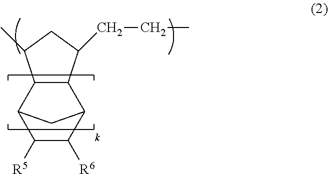

wherein,

R⁵ and R⁶ taken together with the two carbon atoms to which they are attached form a substituted or unsubstituted 3-membered or 5-membered heterocycle having oxygen atom or nitrogen atom, and

k is an integer of 0 to 2.

Further, the cyclic olefin polymer may have repeating units other than the repeating unit of formula (1) and the repeating unit of formula (2).

The polyamide-imide resin may be represented by formula (3) or (4).

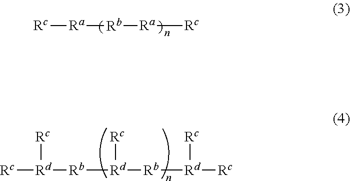

wherein,

R^{b} is a structural unit of any one of formulae (5) to (7),

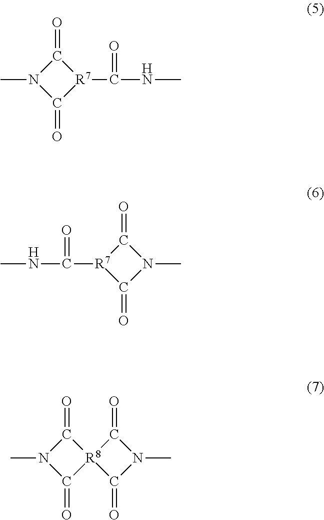

R^{c} is a structural unit of any one of formulae (8) to (12),

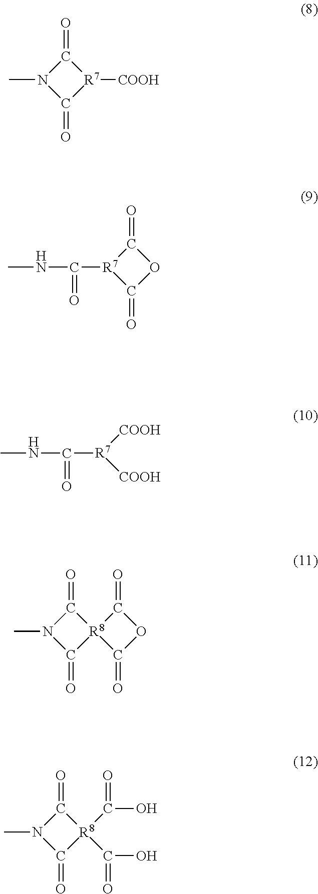

R^{d} is a structural unit of formula (13),

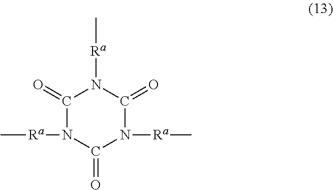

n is an integer of 0 to 30.

R⁷ is a substituted or unsubstituted tricarboxylic anhydride residue having 6 to 20 carbon atoms,

R⁸ is a substituted or unsubstituted tetracarboxylic anhydride residue having 6 to 20 carbon atoms, and

R^{a} is a residue of a divalent aliphatic or alicyclic diisocyanate.

A detailed description of the cyclic olefin polymer and the curing agent comprising the polyamide-imide resin is omitted since it is the same as described in the above-described film touch sensor.

The protective layer forming composition may further comprise components such as resin components and other compounding agents other than the cyclic olefin polymer having a repeating unit of formula (1) and the curing agent comprising the polyamide-imide resin.

Examples of the resin component other than the cyclic olefin polymer having a repeating unit of formula (1) may include a styrene resin, vinyl chloride resin, acrylic resin, polyphenylene esther resin, polyarylene sulfide resin, polycarbonate resin, polyester resin, polyamide resin, polyethersulfone resin, polysulfone resin, polyimide resin, rubber, elastomer, or the like.

Examples of the other compounding agent may include crosslinking agents, sensitizers, surfactants, potential acid generators, antistatic agents, antioxidants, adhesion promoters, antifoaming agents, pigments, dyes, and the like.

As the crosslinking agent, compounds having two or more, and preferably three or more functional groups capable of reacting with the cyclic olefin polymer in a molecule nay be used. The functional group of the crosslinking agent is, for example, carboxyl group, hydroxyl group, epoxy group and the like, more preferably, epoxy group.

Specific examples of the crosslinking agent may include glycollauryls such as N,N′,N″,N′″-(tetraalkoxymethyl)glycollauryl; 1,4-di-(hydroxymethyl)cyclohexane, 1,4-di-(hydroxymethyl)norbornene; 1,3,4-trihydroxycyclohexane and various multifunctional epoxy compounds.

Specific examples of the multifunctional epoxy compound may include, as an epoxy compound having two or more epoxy groups, and preferably, three or more epoxy groups, a compound having an alicyclic structure, compound having a cresol novolac skeleton, compound having a phenol novolac skeleton, compound having a bisphenol A skeleton, compound having a naphthalene skeleton, or the like. Among them, a multifunctional epoxy compound having an alicyclic structure and having two or more, and more preferably three or more epoxy groups is preferably used, in terms of good compatibility with the cyclic olefin polymer.

The molecular weight of the crosslinking agent is not particularly limited, but is commonly 100 to 100,000, preferably 500 to 50,000, and more preferably 1,000 to 10,000. The crosslinking agents may be used alone or in combination of two or more.

Specific examples of the sensitizer may include 2H-pyrid-(3,2-b)-1,4-oxazine-3(4H)-ones, 10H-pyrid-(3,2-b)-1,4-benzothiazines, urazols, hydantoins, barbituric acids, glycine anhydrides, 1-hydroxvbenzotnazoles, alloxans, maleimides, and the like.

The surfactant is used for prevention of striation (coating line strike), improvement of developability, and the like. Specific examples thereof may include nonionic surfactants such as polyoxyethylene alkylethers such as polyoxyethylene laurylether, polyoxyethylene stearylether and polyoxyethylene oleylether, etc.; polyoxyethylene arylethers such as polyoxyethylene octylphenylether, polyoxyethylene nonylphenylether, etc.; polyoxyethylene dialkylesters such as polyoxyethylene dilaurate, polyoxyethylene distearate, etc.; fluorine surfactants; silicone surfactants; methacrylic acid copolymer surfactants; acrylic acid copolymer surfactant, and the like.

The potential acid generator is used for improving the heat resistance and chemical resistance of the protective layer forming composition according to the present invention. Specific examples thereof may include sulfonium salts, benzothiazolium salts, ammonium salts, phosphonium salts, and the like, which are cationic polymerization catalysts that generate acids by heating. Among them, the sulfonium salts and benzothiazolium salts are preferably used.

As the other compounding agents, any compound known in the art can be used.

The form of the protective layer forming composition according to the present invention is not particularly limited, but may be a solution, dispersion or solid. The protective layer forming composition according to the present invention is suitably used in the form of solution or dispersion.

The method of preparing the protective layer forming composition according to the present invention is not particularly limited, but it is preferable to mix the respective components of the protective layer forming composition according to the present invention. However, it is preferred to dissolve or disperse these components in a solvent to obtain a solution or dispersion. The solvent may be removed from the obtained solution or dispersion as necessary.

The solvent used in the present invention is not particularly limited. Specific examples thereof may include alkyleneglycols such as ethyleneglycol, propyleneglycol, diethyleneglycol, triethyleneglycol, tetraethyleneglycol, etc.; alkyleneglycol monoethers such as ethyleneglycol monoethylether, ethyleneglycol propylether, ethyleneglycol mono t-butylether, propyleneglycol ethylether, propyleneglycol monopropylether, propyleneglycol monobutylether, diethyleneglycol monomethylether, diethyleneglycol monoethylether, dipropyleneglycol monomethylether, dipropyleneglycol monoethylether, triethyleneglycol monomethylether, triethyleneglycol monoethylether, tripropyleneglycol monomethylether, tripropyleneglycol monoethylether, etc.; alkyleneglycol dialkylethers such as diethyleneglycol dimethylether, diethyleneglycol diethylether, diethyleneglycol ethylmethylether, dipropyleneglycol dimethylether, dipropyleneglycol diethylether, dipropyleneglycol ethylmethylether, triethyleneglycol dimethylether, triethyleneglycol diethylether, triethyleneglycol ethylmethylether, tripropyleneglycol ethylmethylether, etc.; alkyleneglycol monoalkyletheresters such as propyleneglycol monomethylether acetate, dipropyleneglycol monomethylether acetate, propyleneglycol monoethylether acetate, propyleneglycol mono n-propylether acetate, propyleneglycol mono i-propylether acetate, propyleneglycol mono n-butylether acetate, propyleneglycol mono i-butylether acetate, propyleneglycol mono sec-butylether acetate, propyleneglycol mono t-butylether acetate, etc.; ketones such as methylethylketone, 2-heptanone, 4-hydroxy-4-methyl-2-pentanone, cyclohexanone, cyclopentanone, etc.; alcohols such as methanol, ethanol, propanol, butanol, 3-methoxy-3-methylbutanol, etc.; cyclic ethers such as tetrahydrofuran, dioxane, etc.; cellosolve esters such as methyl cellosolve acetate, ethyl cellosolve acetate, etc.; aromatic hydrocarbons such as benzene, toluene, xylene, etc.; esters such as ethyl acetate, butyl acetate, ethyl lactate, methyl 2-hydroxy-2-methylpropionate, ethyl 2-hydroxy-2-methylpropionate, ethyl ethoxyacetate, ethyl hydroxyacetate, methyl 2-hydroxy-3-methyl butanoate, methyl 3-methoxypropionate, ethyl 3-methoxypropionate, ethyl 3-ethoxypropionate, methyl 3-ethoxypropionate, γ-butyrolactone etc.; amides such as N-methylformamide, N,N-dimethylformamide, N-methyl-2-pyrrolidone, N-methylacetamide, N,N-dimethylacetoamide, etc.; sulfoxides such as dimethyl sulfoxide, or the like.

These solvents may be used alone or in combination of two or more. The amount of the solvent to be used is commonly 50 to 90% by weight based on 100% by weight of the total protective layer forming composition.

The method of dissolving or dispersing the respective components constituting the protective layer forming composition according to the present invention in a solvent may be carried out according to a conventional method. Specifically, the method may be carried out by using stirring with a stirrer or magnetic stirrer, high-speed homogenizer, disperser, planetary stirrer, biaxial stirrer, ball mill, roll mill or the like. After dissolving or dispersing the respective components in a solvent, they may be filtered using, for example, a filter having a pore diameter of about 0.5 μm.

When dissolving or dispersing the respective components constituting the protective layer forming composition according to the present invention in a solvent, the solid content is commonly in the range of 1 to 70% by weight, preferably 5 to 50% by weight, and more preferably 10 to 40% by weight. When the solid content is within the above range, the dissolution stability, coatability, thickness uniformity of the formed film, flatness and the like may be highly balanced.

The application method of the protective layer forming composition is not particularly limited, but may include any conventional method known in the art, for example, slit coating, knife coating, spin coating, casting, micro gravure coating, gravure coating, bar coating, roll coating, wire-bar coating, dip coating, spray coating, screen printing, gravure printing, flexo printing, offset printing, ink-jet coating, dispenser printing, nozzle coating, capillary coating, or the like.

The protective layer 30 may be formed by curing the applied protective layer forming composition.

The curing may be performed by drying the applied composition.

The drying may be performed by a process including, for example, a pre-bake step and a post-bake step.

The pre-bake method is not particularly limited, but for example, may be performed by heating in a hot plate or oven, irradiating with infrared rays, or the like, and preferably using a convection oven.

The pre-bake may be carried out at a temperature of, for example, 100° C. to 120° C. If the temperature is lower than 100° C., the solvent component may remain to cause coating defects. If the temperature exceeds 120° C., the elasticity may be lowered.

The pre-bake may be performed, for example, for 1 minute to 3 minutes. If the pre-bake time is less than 1 minute, the solvent component remains, so that processability is deteriorated, and if the pre-bake time exceeds 3 minutes, coating stains may occur.

The post-bake method is not particularly limited, but for example, may be performed by heating in a hot plate or oven, irradiating with infrared rays, or the like, and preferably using a convection oven.

The post-bake may be performed at a temperature of, for example, 180° C. to 250° C. If the temperature is lower than 180° C., the resistance of the electrode pattern layer 40 may increase due to out-gas, and the density may increase to cause cracks during peeling from the carrier substrate. If the temperature exceeds 250° C., the transmittance may be lowered by a yellowing phenomenon.

The post-bake may be performed for 20 minutes to 60 minutes, for example. If the post-bake time is shorter than 20 minutes, curing is not sufficiently performed to cause wrinkles on the protective layer 30 during the formation of the electrode pattern, and if the post-bake time exceeds 60 minutes, the transmittance may be lowered by the yellowing phenomenon.

Next, as illustrated in FIG. 3c, an electrode pattern layer 40 is formed on the protective layer 30.

First, an ITO transparent conductive layer is formed as a transparent conductive layer and a photosensitive resist (not shown) is formed thereon. Then, a photolithography procedure for selective patterning is carried out to form the electrode pattern layer 40, as shown in FIG. 3c.

The transparent conductive layer may be formed by a sputtering method such as chemical vapor deposition (CVD), physical vapor deposition (PVD), plasma enhanced chemical vapor deposition (PECVD); a printing method such as screen printing, gravure printing, reverse offset, ink jet; or a wetting or drying plating method. Particularly, the sputtering may be carried out in a state that a mask having a desired electrode pattern shape is disposed on a substrate to form the electrode pattern layer. Alternatively, the electrode pattern may be formed by photolithography after forming the conductive layer on the entire area by the above-mentioned forming methods.

As the photosensitive resist, a negative-type photosensitive resist or a positive-type photosensitive resist may be used. As necessary, the resist may be remained on the electrode pattern layer 40, or may be removed. In this embodiment, a positive-type photosensitive resist is used and is removed from the electrode pattern after patterning.

In the electrode pattern formation, an additional electrode pattern formation process may be further added according to the electrode pattern structure.

Thereafter, an insulation layer 50 is formed to cover the electrode pattern laver 40, as shown in FIG. 3d. The insulation layer 50 may have the same thickness as the electrode or may be thicker than the electrode such that the insulation layer has a planarized upper surface. That is, the insulation layer is preferably formed from an insulating material having suitable viscoelasticity so that the uneven part of the electrode is not transferred.

Specifically, a liquid material to form the insulation layer is coated on the electrode pattern layer, followed by thermal curing or UV curing to form the insulation layer.

The coating method for forming the insulation layer may be carried out by a conventional coating method known in the art.

For example, spin coating, die coating, spray coating, roll coating, screen coating, slit coating, dip coating, gravure coating and the like may be mentioned.

Then, as shown in FIG. 3e, the separation layer 20 on which the electrode is formed is separated from the carrier substrate 10 which is used for the preparation process of the touch sensor.

In the present invention, the separation layer 20 is separated from the carrier substrate 10 by a peeling method.

Examples of the peeling method may include lift-off and peel-off, but are not limited thereto.

For the peeling, a force of 1N/25 mm or less, preferably 0.1N/25 mm or less may be applied, but the force may be varied depending on the peeling strength of the separation layer. If the peeling strength exceeds 1N/25 mm, the film touch sensor may be tom during peeling from the carrier substrate, and an excessive force may be applied to the film touch sensor, thereby causing the deformation of the film touch sensor and failing to function as a device.

Through the above-described processes, a laminate in which the separation layer 20, the protective layer 30, the electrode pattern layer 40, and the insulation layer 50 are sequentially stacked on the carrier substrate 10 can be obtained, and the laminate can be used as a film touch sensor after peeling the separation layer 20 from the carrier substrate 10.

The preparation method of the film touch sensor of the present invention may further comprise the step of attaching a base film 60 onto the insulation layer 50 (not shown).

In this case, the peeling process may be performed before or after the attachment of the base film 60.

The film touch sensor according to one embodiment of the present invention may be applied to various display panels. Accordingly, one embodiment of the present invention relates to a display device comprising the film touch sensor.

As the display panel, a liquid crystal display (LCD) panel, a plasma display panel (PDP), an organic light emitting diode (OLED) panel, and an electrophoretic display (EPD) panel and the like may be exemplified.

Hereinafter, the present invention will be described in more detail by way of Examples, Comparative Examples and Experimental Examples. However, these Examples, Comparative Examples and Experimental Examples are given for illustrative purposes only, and it is apparent to those skilled in the art that the scope of the invention is not intended to be limited thereto.

### Synthesis Example 1: Synthesis of Cyclic Olefin Polymer A-1

60 parts by weight of 8-hydroxy carbonyl tetracyclododecene, 40 parts by weight of N-(4-phenyl)-(5-norbornene-2,3-dicarboxyimide), 1.3 parts by weight of 1-hexene, 0.05 parts by weight of (1,3-dimethylimidazolidin-2-ylidene) (tricyclohexylphosphine) benzylideneruthenium dichloride and 400 parts by weight of tetrahydrofuran were introduced into a glass pressure-reactor substituted with nitrogen, and reacted at 70° C. for 2 hours while stirring to obtain a resin solution (a) (solid content: about 20% by weight). The resin solution (a) was transferred into an autoclave equipped with a stirrer, and reacted at a hydrogen pressure of 4 MPa and a temperature of 150° C. for 5 hours to obtain a resin solution (b) containing a hydrogenated resin (hydrogenation rate 99%) (solid content: about 20% by weight). Then, 100 parts by weight of the resin solution (b) and 1 part by weight of activated carbon powder were put into a heat resistant autoclave and reacted at a hydrogen pressure of 4 MPa and a temperature of 150° C. for 3 hours. After the completion of the reaction, the reaction solution was filtered through a fluororesin filter having a pore diameter of 0.2 μm to separate the activated carbon, to obtain a resin solution (c). At this time, the solution was smoothly filtered. Then, the resin solution (c) was added into ethyl alcohol. The resulting solid was dried to obtain a cyclic olefin polymer A-1. The cyclic olefin polymer A-1 had Mw of 5,500 and Mn of 3,200 in terms of polystyrene standards, glass transition temperature (Tg) of 187° C., and molecular weight distribution of 1.7. In addition, the hydrogenation rate was 99%.

### Synthesis Example 2: Synthesis of Polymer A-2

In an 1 L flask equipped with a reflux condenser, a dropping funnel and a stirrer, nitrogen was flowed at 0.02 L/min to make a nitrogen atmosphere, and 150 g of diethylene glycol methyl ethyl ether was added thereto and heated to 70° C. while stirring. Then, 132.2 g (0.60 mol) of a mixture of the following formula (a) and formula (b) (molar ratio 50:50), 55.3 g (0.30 mol) of 3-ethyl-3-oxetanyl methacrylate, and 8.6 g (0.10 mol) of methacrylic acid dissolved in 100 g of diethylene glycol methyl ethyl ether was added thereto.

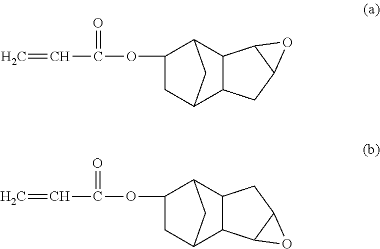 [SMILES: C=CC(=O)OC1CC2CC1C1C2CC2OC21 ; C=CC(=O)OC1CC2CC1C1CC3OC3C21]

The prepared solution was added dropwise into the flask using the dropping funnel, and then 27.9 g (0.11 mol) of 2,2′-azobis(2,4-dimethylvaleronitrile) as a polymerization initiator dissolved in 200 g of diethylene glycol methyl ethyl ether was added dropwise into the flask using a separate dropping funnel over 4 hours. After the dropwise addition of the polymerization initiator solution was completed, the temperature was maintained at 70° C. for 4 hours, and then cooled to room temperature to obtain a copolymer (polymer A-2) solution having a solid content of 41.8 mass % and an acid value of 62 mg-KOH/g (in terms of solid content). The polymer had a weight average molecular weight (Mw) of 8,000 and a molecular weight distribution of 1.82.

### Preparation Example 1: Preparation of Curing Agent B-1

In a flask equipped with a stirrer, a thermometer and a condenser, 1086 g of PGMAc (propylene glycol monomethyl ether acetate), 587.3 g (0.80 mol) of IPDI3N (isocyanurate type triisocyanate synthesized from isophorone diisocyanate: NCO %=17.2) and 499.1 g (2.52 mol) of cyclohexane-1,3,4-tricarboxylic acid-3,4-anhydride were added and heated to 140° C. The reaction proceeded with foaming. The reaction was performed at this temperature for 8 hours. The reaction solution became a faintly-yellow liquid in the system. As a result of measuring characteristic absorption by an infrared spectrum, an absorption at 2270 cm⁻¹, which is characteristic absorption of an isocyanate group, completely disappeared, and absorption of an imide group was observed at 1780 cm⁻¹ and 1720 cm⁻¹. The acid value was 212 KOHmg/g based on solid content, and the number average molecular weight (Mn) in terms of polystyrene standards was 4,700. The concentration of an acid anhydride group was 1.14 mmol/g based on solid content. The concentration of resin was 47.4 mass %.

### Preparation Example 2: Preparation of Curing Agent B-2

In a flask equipped with a stirrer, a thermometer and a condenser, 1496 parts by weight of EDGA (diethylene glycol monomethyl ether acetate), 888 parts by weight (4 mol) of IPDI (isophorone diisocyanate) and 960 parts by weight (5 mol) of trimellitic anhydride were added and heated to 160° C. The reaction proceeded with foaming. The reaction was performed at this temperature for 4 hours. The reaction solution became a faintly-brown liquid in the system. As a result of measuring characteristic absorption by an infrared spectrum, an absorption at 2270 cm⁻¹, which is characteristic absorption of an isocyanate group, completely disappeared, and absorption of an imide group was observed at 725 cm⁻¹, 1780 cm⁻¹ and 1720 cm⁻¹. The acid value was 85 KOHmg/g based on solid content, and the number average molecular weight (Mn) in terms of polystyrene standards was 1,600.

### Preparation Example 3: Preparation of Curing Agent B-3

In a flask equipped with a stirrer, a thermometer and a condenser, 2488 parts by weight of EDGA (diethylene glycol monomethyl ether acetate), 1398 parts by weight (2 mol) of IPDI3N (isocyanurate type triisocyanate of isophorone diisocyanate: NCO %=18.2), 768 parts by weight (4 mol) of trimellitic anhydride, and 322 parts by weight (1 mol) of benzophenone tetracarboxylic dianhydride (BPDA) were added and heated to 120° C. The reaction proceeded with foaming. The reaction was performed at this temperature for 8 hours. The reaction solution became an orange liquid in the system. As a result of measuring characteristic absorption by an infrared spectrum, an absorption at 2270 cm⁻¹, which is characteristic absorption of an isocyanate group, completely disappeared, and absorption of an imide group was observed at 725 cm⁻¹, 1780 cm⁻¹ and 1720 cm⁻¹. The acid value was 140 KOHmg/g based on solid content, and the number average molecular weight (Mn) in terms of polystyrene standards was 2,900.

### Examples 1 to 9 and Comparative Examples 1 to 2: Manufacture of Film Touch Sensor

Compositions for forming a protective layer were prepared by mixing each component with the composition shown in Table 1 below (unit: parts by weight).

TABLE 1

| | (A) Polymer | | (B) Curing Agent | | | (C) Solvent |
|---|---|---|---|---|---|---|
| Item | A-1 | A-2 | B-1 | B-2 | B-3 | C-1 |
| Example 1 | 13.83 | — | 0.49 | — | — | 81.73 |
| Example 2 | 13.30 | — | 2.01 | — | — | 80.89 |
| Example 3 | 12.94 | — | 3.03 | — | — | 80.33 |
| Example 4 | 13.83 | — | — | 0.49 | — | 81.73 |
| Example 5 | 13.30 | — | — | 2.01 | — | 80.89 |
| Example 6 | 12.94 | — | — | 3.03 | — | 80.33 |
| Example 7 | 13.83 | — | — | — | 0.49 | 81.73 |
| Example 8 | 13.30 | — | — | — | 2.01 | 80.89 |
| Example 9 | 12.94 | — | — | — | 3.03 | 80.33 |
| Comparative | 7.85 | — | 17.58 | — | — | 72.33 |
| Example 1 | | | | | | |
| Comparative | — | 19.75 | 0.49 | — | — | 78.97 |
| Example 2 | | | | | | |

A-1: Cyclic Olefin Polymer of Synthesis Example 1
A-2: Acrylic Polymer of Synthesis Example 2
B-1: Curing Agent of Preparation Example 1
B-2: Curing Agent of Preparation Example 2
B-3: Curing Agent of Preparation Example 3
C-1: Diethylene glycol ethyl methyl ether (MEDG)

A film touch sensor was manufactured using the protective layer forming composition as follows.

A soda lime glass having a thickness of 700 μm was used as a carrier substrate, and a separation layer composition comprising 50 parts by weight of a melamine-based resin and 50 parts by weight of a cinnamate-based resin diluted with propylene glycol monomethyl ether acetate (PGMEA) in a concentration of 10% by weight was applied with a thickness of 300 nm on the carrier substrate and dried at 150° C. for 30 minutes to form a separation layer.

Then, a protective layer was formed on the separation layer using the protective layer forming composition. Specifically, the composition was applied with a thickness of 2 μm with a spin coater and pre-baked at 110° C. for 2 minutes in a convection oven. Then, post-bake was performed at 230° C. for 30 minutes to form a protective layer.

Thereafter, ITO was deposited on the protective layer with a thickness of 45 nm at room temperature of 25° C., and the ITO layer was annealed at 230° C. for 30 minutes to form an electrode pattern layer.

After that, an insulation layer was formed on the electrode pattern layer using an acrylic insulation material.

Thereafter, a pressure-sensitive adhesive composition, which comprises CEL2021P ((3,4-epoxycyclohexane)methyl 3,4-epoxycyclohexylcarboxylate), neopentyl glycol diglycidyl ether, 1,6-hexanediol diacrylate, trimethylol propane triacrylate as a monomer, KRM0273 as an adhesion promoter, 4-HBVE as a diluting monomer, SP500 as a polymerization initiator, and KRM230 as a leveling agent, was applied between a 60 μm-thick polarizer (base film) and the insulation layer using a pipet, and pressed by a roll laminator to form a pressure-sensitive adhesive layer having a thickness of 2 μm. The pressure-sensitive adhesive layer was irradiated with UV rays having an intensity of 10 mW/cm² for 100 seconds for adhesion, then dried in an oven at 80° C. for 10 minutes, and then left to stand until the temperature reached room temperature.

### Experimental Example 1

The film touch sensors prepared in Examples and Comparative Examples were measured for their physical properties according to the methods described below, and the results thereof are shown in Table 2 below.

(1) Optical Characteristics (Transmittance, b*)

Independently from the film touch sensors prepared in the Examples and Comparative Examples, only a protective layer was formed on an alkali-free glass (Eagle XG Glass, Samsung Corning) having a thickness of 700 μm by the same manner as in the Examples. The light transmittance at a wavelength of 550 nm of the protective layer was measured using a spectrophotometer (KOINICA MINOLTA, CM 2550).

(2) Measurement of Amended Toughness

Specimens of length 50 mm×width 5 mm were prepared using the film touch sensors of Examples and Comparative Examples. The amended toughness was measured using an AUTOGRAPH AG-X 1KN instrument from SHIMAZHU. Specifically, the specimen was pulled at a constant tensile speed of 4 mm/min in the longitudinal direction, and the stress depending on the strain was measured until break to obtain the stress and strain at the breaking point.

Thereafter, the amended toughness was calculated by multiplying the stress and strain at the breaking point.

TABLE 2

| | Optical Characteristics | | Amended | |
|---|---|---|---|---|
| | Tt | b* | Toughness | Note |
| Example 1 | 92.31 | 0.18 | 275.1 | |
| Example 2 | 92.33 | 0.12 | 254.4 | |
| Example 3 | 92.36 | 0.19 | 246.7 | |
| Example 4 | 92.30 | 0.22 | 240 | |
| Example 5 | 92.30 | 0.23 | 228 | |
| Example 6 | 92.26 | 0.245 | 235 | |
| Example 7 | 92.30 | 0.21 | 219 | |
| Example 8 | 97.28 | 0.25 | 234 | |
| Example 9 | 92.31 | 0.74 | 222 | |
| Comparative | — | — | — | no film formation |
| Example 1 | | | | |
| Comparative | 92.425 | 0.39 | 182 | |
| Example 2 | | | | |

As shown in Table 2, it was confirmed that the film touch sensors of Examples 1 to 9 according to the present invention showed excellent optical characteristics of the protective layer and improved mechanical properties, thereby suppressing the occurrence of cracks in the film touch sensor. On the other hand, in the case of the film touch sensors according to Comparative Examples 1 to 2, optical characteristics of the protective layer and mechanical properties were deteriorated, or film formation was impossible.

Although specific parts of the present invention have been described in detail, it will be apparent to those skilled in the art that these specific descriptions are merely a preferred embodiment and that the scope of the present invention is not limited thereto. In addition, those skilled in the art will appreciate that various applications and modifications are possible, without departing from the scope and spirit of the invention based on the description above.

Therefore, the substantial scope of the present invention will be defined by the accompanying claims and their equivalents.

1. A film touch sensor, comprising:
a separation layer;
a protective layer formed on the separation layer;
an electrode pattern layer formed on the protective layer; and
an insulation layer formed on the electrode pattern layer,
wherein the protective layer is a cured layer of a protective layer forming composition comprising a cyclic olefin polymer having a repeating unit of formula (1) and a curing agent comprising a polyamide-imide resin,
wherein a mixing ratio of the cyclic olefin polymer to the curing agent is 30:1 to 4:1 by weight: 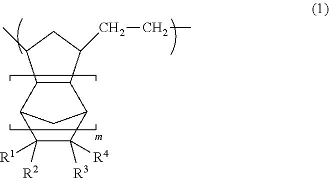
wherein,
R¹ to R⁴ are each independently hydrogen atom or —Xₙ—R′,
X is a divalent organic functional group, n is 0 or 1, and R′ is a substituted or unsubstituted C₁-C₇ alkyl group, a substituted or unsubstituted aromatic group, or a protonic polar group,
at least one of R¹ to R⁴ is —Xₙ—R′ wherein R′ is a protonic polar group, and
m is an integer of 0 to 2.

2. The film touch sensor according to claim 1, wherein the protonic polar group is selected from a group consisting of a carboxyl group, sulfonic acid group, phosphoric acid group, hydroxyl group, amino group, amide group, imide group and thiol group.

3. The film touch sensor according to claim 1, wherein the cyclic olefin polymer further has a repeating unit of formula (2): 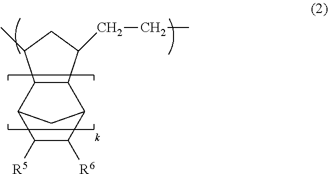
wherein,
R⁵ and R⁶ taken together with the two carbon atoms to which they are attached form a substituted or unsubstituted 3-membered or 5-membered heterocycle having oxygen atom or nitrogen atom, and
k is an integer of 0 to 2.

4. The film touch sensor according to claim 1, wherein the cyclic olefin polymer has a weight average molecular weight of 5,000 to 150,000.

5. The film touch sensor according to claim 1, wherein the cyclic olefin polymer has a glass transition temperature of 100° C. or higher.

6. The film touch sensor according to claim 1, wherein the polyamide-imide resin is represented by formula (3) or (4): 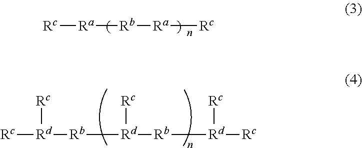
wherein,
R^{b} is a structural unit of any one of formulae (5) to (7), 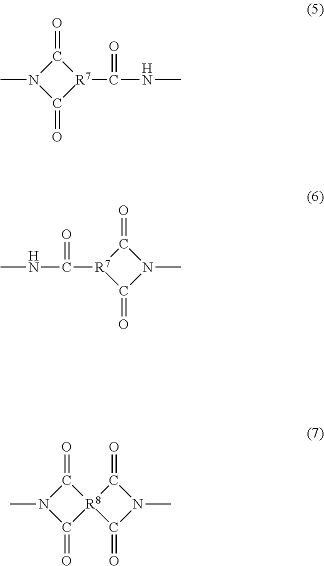
R^{c} is a structural unit of any one of formulae (8) to (12), 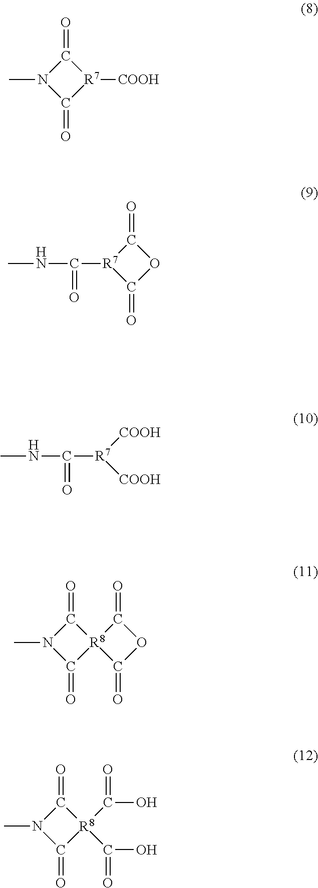
R^{d} is a structural unit of formula (13), 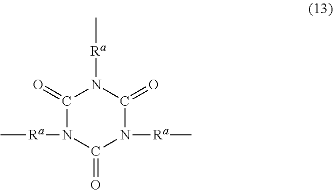
n is an integer of 0 to 30,
R⁷ is a substituted or unsubstituted tricarboxylic anhydride residue having 6 to 20 carbon atoms,
R⁸ is a substituted or unsubstituted tetracarboxylic anhydride residue having 6 to 20 carbon atoms, and
R^{a} is a residue of a divalent aliphatic or alicyclic diisocyanate.

7. The film touch sensor according to claim 1, wherein the protective layer has an elastic modulus of 2.8 to 4.5 GPa.

8. The film touch sensor according to claim 1, wherein the protective layer has a transmittance of 90% or more.

9. A method for preparing a film touch sensor, comprising the steps of:
a separation layer formation step of forming a separation layer on a carrier substrate;
a protective layer formation step of forming a protective layer on the separation layer;
an electrode pattern layer formation step of forming an electrode pattern layer on the protective layer; and
an insulation layer formation step of forming an insulation layer on the electrode pattern layer,
wherein the protective layer is a cured layer of a protective layer forming composition comprising a cyclic olefin polymer having a repeating unit of formula (1) and a curing agent comprising a polyamide-imide resin,
wherein a mixing ratio of the cyclic olefin polymer to the curing agent is 30:1 to 4:1 by weight: 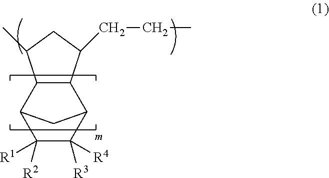
wherein,
R¹ to R⁴ are each independently hydrogen atom or —Xₙ—R′,
X is a divalent organic functional group, n is 0 or 1, and R′ is a substituted or unsubstituted C₁-C₇ alkyl group, a substituted or unsubstituted aromatic group, or a protonic polar group,
at least one of R¹ to R⁴ is —Xₙ—R′ wherein R′ is a protonic polar group, and
m is an integer of 0 to 2.

10. The method for preparing a film touch sensor according to claim 9, wherein the cyclic olefin polymer further has a repeating unit of formula (2): 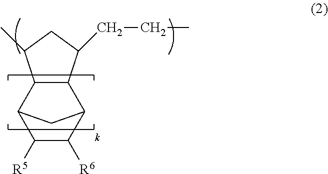
wherein,
R⁵ and R⁶ taken together with the two carbon atoms to which they are attached form a substituted or unsubstituted 3-membered or 5-membered heterocycle having oxygen atom or nitrogen atom, and
k is an integer of 0 to 2.

11. The method for preparing a film touch sensor according to claim 9, wherein the polyamide-imide resin is represented by formula (3) or (4): 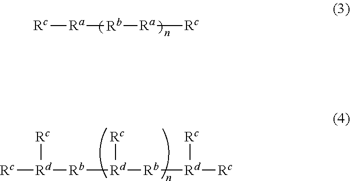
wherein,
R^{b} is a structural unit of any one of formulae (5) to (7), 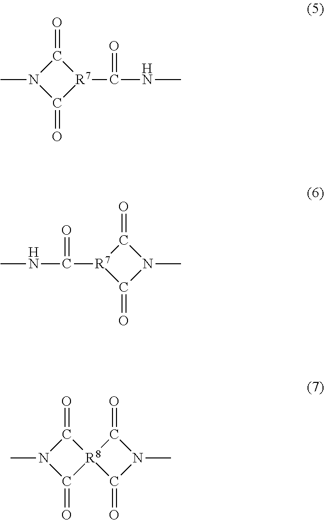
R^{c} is a structural unit of any one of formulae (8) to (12), 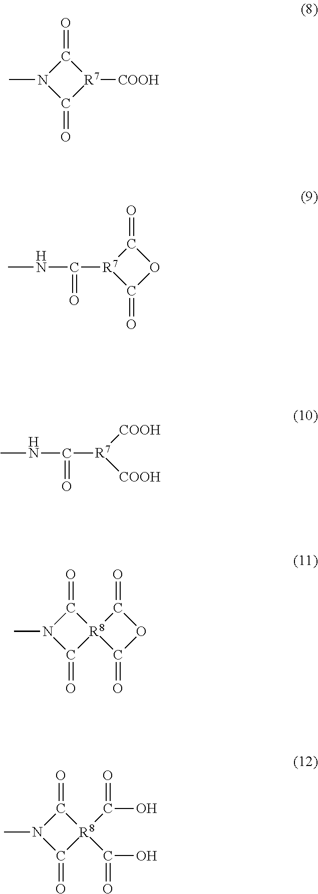
R^{d} is a structural unit of formula (13), 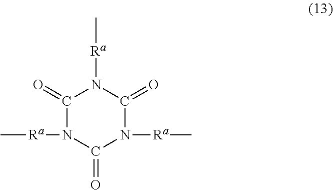
n is an integer of 0 to 30,
R⁷ is a substituted or unsubstituted tricarboxylic anhydride residue having 6 to 20 carbon atoms,
R⁸ is a substituted or unsubstituted tetracarboxylic anhydride residue having 6 to 20 carbon atoms, and
R^{a} is a residue of a divalent aliphatic or alicyclic diisocyanate.

12. A display device including the film touch sensor according to claim 1.

13. A display device including the film touch sensor according to claim 2.

14. A display device including the film touch sensor according to claim 3.

15. A display device including the film touch sensor according to claim 4.

16. A display device including the film touch sensor according to claim 5.

17. A display device including the film touch sensor according to claim 6.

18. A display device including the film touch sensor according to claim 7.

19. A display device including the film touch sensor according to claim 8.
